(19) United States
(12) Patent Application Publication
(10) Pub. No.: US 2010/0323080 A1
(43) Pub. Date: Dec. 23, 2010

(54) FOOD COMPOSITIONS FOR SALTING IN PARTICULAR

(75) Inventor: Christian Leclerc, Dun-sur-Auron (FR)

Correspondence Address: HARNESS, DICKEY & PIERCE, P.L.C., P.O. BOX 828, BLOOMFIELD HILLS, MI, 48303, US

(73) Assignee: NUTRACEUTICS D&S, Saint Bonnet De Rochefort (DE)

(21) Appl. No.: 12/446,178

(22) PCT Filed: Oct. 16, 2007
(86) PCT No.: PCT/FR2007/052164

§ 371 Date: Sep. 16, 2009

(30) Foreign Application Priority Data
Oct. 18, 2006 (EP) 06291620.0

(51) Int. Cl. A23L 1/40; A23L 1/237; A23L 1/00; A23L 1/31

(52) U.S. Cl. 426/589; 426/648; 426/649; 426/618; 426/641

(57) ABSTRACT

The application relates, in particular, to a salting composition comprising at least two potassium salts at least one of which is a potassium organic salt. The application likewise relates to a method of preparing a food product comprising at least one step consisting of adding said composition to a food product. Finally, the application also relates to the use of said composition as a salting agent.

### CROSS REFERENCE TO RELATED APPLICATIONS

This is a National Phase Entry of International Application No. PCT/FR2007/052164, filed Oct. 16, 2007, which claims priority to European Patent Application No. 06291620.0, filed Oct. 18, 2006. Both of these applications are incorporated by reference herein.

### BACKGROUND AND SUMMARY

This invention relates to the field of foodstuffs. It relates most especially to a composition for salting in particular, to a method of preparing a food product, which includes a step for adding said composition, as well as to the use of said composition.

The salt used in agro-processing is usually an evaporated salt comprising more than 95% sodium chloride and a few adjuvants such as anti-caking agents and/or iodated or fluorinated compounds. However, excessive consumption of sodium chloride is the source of numerous disorders and diseases the prevalence of which continues to grow. This is why, in order to reduce diseases associated with excessive consumption of sodium chloride, compositions low in sodium chloride were developed.

Generally speaking, the compositions of the prior art replace sodium with potassium, because a dietary intake high in potassium enables several major diseases to be combated, particularly hypertension, strokes, osteoporosis, nephrolithiases and diabetes. However, the organoleptic qualities of the low sodium chloride compositions of the prior art are generally inferior to those of sodium chloride. Furthermore, these compositions are not fully suitable for certain uses as a salting agent for bread making or the agro-processing industry.

The invention aims to remedy all or a portion of these problems by proposing a composition which is lower in sodium chloride while at the same time possessing satisfactory organoleptic qualities, which are close, in particular, to those of sodium chloride. The composition according to the invention is particularly suitable for use as a salting agent in bread making, because, in particular, it makes it possible to reduce the fermentation time of the bread dough and to increase the elasticity thereof, thereby facilitating the kneading of same. Furthermore, in the agro-processing industry, the compositions according to the invention make it possible, in particular, to increase the sheen and/or colour intensity of the food products.

To that end, and according to a first aspect, the object of the invention is a composition comprising at least two potassium salts of which at one of the two potassium salts is a potassium organic salt. In particular, said composition according to the invention is devoid of sodium chloride. The composition according to the invention can further include sodium chloride. The composition according to the invention can include a sodium chloride content less than or equal to 2% by weight in relation to the total weight of the composition.

In particular, in the composition according to the invention, the potassium salts can be chosen from the group comprising potassium carbonate, potassium bicarbonate, potassium organic salts, potassium mineral salts such as potassium chloride, and a mixture thereof. According to the invention, the potassium organic salt can be chosen from the group comprising citrate, tartrate, adipate, succinate, glutamate and potassium malate, and preferably potassium citrate. In particular, the composition according to the invention includes a potassium organic salt content ranging from 50 to 95%, and preferably from 60 to 80% by weight in relation to the total weight of the composition. In particular, the composition according to the invention is devoid of glutamic acid, calcium salt and/or ammonium salt.

According to a first embodiment, the composition according to the invention includes potassium carbonate or bicarbonate and a potassium organic salt. The weight ratio of potassium organic salt to potassium carbonate or bicarbonate can range from 1 to 10, particularly from 1.5 to 7.5, and in particular from 2 to 4, or even 3. According to a second embodiment, the composition according to the invention includes potassium chloride, a potassium organic salt and sodium carbonate or bicarbonate. The weight ratio of potassium organic salt to sodium carbonate or bicarbonate can range from 1 to 10, particularly from 1.5 to 7.5, and in particular from 2 to 4, or even 3.

In particular, the composition according to the invention further includes silica. The composition according to the invention can include a silica contain ranging from 0.05% to 5%, in particular from 0.1% to 2.5%, and most particularly from 0.2% to 1% by weight in relation to the total weight of the composition.

The composition according to the invention can be in various forms which are suited, in particular, for use in food. In particular, it is in the form of a powder. According to a second aspect, another object of the invention is a method of preparing a food product comprising at least one step consisting in adding the composition according to the invention to a food product. In particular, the food product is chosen from the group comprising bread, prepared meals, soups, sauces, pizzas, meats, delicatessen foods, and preferably bread.

According to a third aspect, another object of the invention is the use of a composition according to the invention as a salting agent. Finally, according to a fourth aspect, another object of the invention is the use of a composition according to the invention as a sodium chloride substitute.

### DETAILED DESCRIPTION

Compositions according to the invention are presented hereinbelow for illustrative purposes. The following examples disclose three possible mixtures.

1)Mixture 1 comprises:
60% by weight potassium citrate;
20% by weight NaHCO₃;
19.8% by weight KCI; and
0.2% by weight SiO₂.

2) Mixture 2 comprises:
75% by weight potassium citrate; and
25% by weight KHCO₃.

3) Mixture 3 comprises:
60% by weight potassium citrate;
20% by weight NaHCO₃;
19.8% by weight KHCO₃; and
0.2% by weight SiO₂.

Examples of using the composition according to the invention as a sodium chloride substitute in various food products are presented hereinbelow. In a mode of use, mixtures 1 to 3 are incorporated according to different proportions to sodium chloride in order to substitute part of it. In another mode of use, mixtures 1 to 3 substitute the sodium chloride in proportions ranging from 18% to 70%.

The following table presents the percentages by weight of the various compounds of mixtures 1 to 3, in relation to the total weight of the composition, on the basis of the sodium chloride substitution percentages by one of said mixtures.

| | Pure | | | | |
|---|---|---|---|---|---|
| Substitution % | mixture | A: 70% | B: 50% | C: 30% | D: 18% |
| Mixture 1 | | | | | |
| Potassium | 60 | 42 | 30 | 18 | 10.8 |
| citrate | | | | | |
| NaHCO₃ | 20 | 14 | 10 | 6 | 3.6 |
| KCl | 19.8 | 13.86 | 9.9 | 5.94 | 3.564 |
| SiO₂ | 0.2 | 0.14 | 0.1 | 0.06 | 0.036 |
| NaCl | 0 | 30 | 50 | 70 | 82 |
| Mixture 2 | | | | | |
| Potassium | 75 | 52.5 | 37.5 | 22.5 | 13.5 |
| citrate | | | | | |
| KHCO₃ | 25 | 17.5 | 12.5 | 7.5 | 4.5 |
| NaCl | 0 | 30 | 50 | 70 | 82 |
| Mixture 3 | | | | | |
| Potassium | 60 | 42 | 30 | 18 | 10.8 |
| citrate | | | | | |
| KHCO₃ | 19.8 | 13.86 | 9.9 | 5.94 | 3.564 |
| SiO₂ | 0.2 | 0.14 | 0.1 | 0.06 | 0.036 |
| NaCl | 20 | 44 | 60 | 76 | 85.6 |

The composition according to the invention is advantageously used in traditional bakery or commercial bread making. Tests conducted, on the one hand, in a commercial bakery and, on the other hand, in a commercial bread making plant are provided below in order to illustrate the surprising advantages of the composition according to the invention in terms of bread making.

In an artisan bakery, the method of preparing “test” bread baguettes comprises the following steps:

a)Mixing the following ingredients in a spiral mixer for approximately 6 minutes:
3 litres of water;
5 kg of flour (T55+15 g of cracked whole wheat;
2 kg of liquid leaven;
50 g of yeast;
50 g of butter;
20 g of a salting composition per kg of flour, i.e. 100 g.

b)Allowing the mixture thus produced to rest en masse at room temperature for approximately 1 hour and 30 minutes. This step enables a first fermentation to be carried out and the development of flavours.

c)Dividing the mixture into balls of equal weight.

d)Intermediate proofing of the dough for 20 minutes.

e)Moulding of the balls into the shape of baguettes

f)Resting of the baguettes for 1 hour at room temperature in order to carry out a second fermentation.

g)Baking of the baguettes.

In order to test the influence of the composition according to the invention on the production of the bread and on the organoleptic qualities thereof, control baguettes were prepared with 18 g of sodium chloride per kg of flour, and “test” baguettes were prepared with 20 g per kg of flour of the composition according to the invention for which the sodium chloride is substituted at 30%, 50% and 70% of the total weight, per mixture 1.

As a result of using a composition according to the invention, it is observed that the “test” baguettes undergo a more rapid fermentation than the control baguettes. Thus, for the control baguettes, resting for one hour at room temperature enables only a poor degree of fermentation to be obtained. Therefore, in order to obtain a degree of fermentation similar to the “test” baguettes, the control baguettes are left to rest at a controlled temperature of approximately 15° C. for one night. Consequently, the use of the composition according to the invention enables the preparation time to be reduced.

During the rounding operation, the “test” baguette dough is relaxed in comparison with the control baguette dough. However, after intermediate proofing of the dough, no marked difference is noted in the physical properties of the dough. In addition, after baking, the “test” baguettes have an outer appearance similar to that of the control baguettes and possess a crumb having shiny and irregular cells, a sign of a high-quality baguette.

In order to determine acceptance of the composition according to the invention by consumers, sensory tests were carried out. The results show that, from a taste perspective, the substitution of sodium chloride by a composition according to the invention is satisfactory. As a matter of fact, close to 40% of the subjects tested do not distinguish any difference with a control baguette. Nonetheless, when the sodium chloride is substituted by 50%, it is observed that the lack of a salty sensation begins to be felt, and, when the sodium chloride is substituted by 70%, the baguettes are bland.

In order to complete the study of the impact of using a composition according to the invention on bread making, experimental tests were conducted at the commercial bread making scale on control breads T1 and T2, which were prepared with 18 and 22 g of sodium chloride per kg of flour, respectively, and on “test” breads E1, E2, E3, which were prepared with 22 g of a composition according to the invention the sodium chloride of which was substituted by 18%, 32% and 50%, respectively, per mixture 1. These studies confirm that the use of the composition according to the invention makes it possible to reduce the fermentation time and therefore the production costs.

Furthermore, during kneading of the dough, the blending, elasticity and extensibility of the dough was evaluated and the following results were observed:

Blending of the dough is identical for breads T1, T2 and E1.

Breads E1, E2 and E3 have a greater degree of consistency than T1 and T2.

The degree of kneading elasticity is greater for E1 than for T1 and T2.

The extensibility levels of E1 and T1 are similar but lower than that of T2.

The stickiness of the doughs is identical for T1, T2, E1, E2 and E3.

Consequently, it is noted that the composition according to the invention enables the elasticity of the dough to be increased. Kneading, which is an operation consisting in giving dough elasticity and flexibility, is thereby facilitated.

During the moulding operation, which is likewise called dough-piece moulding, elasticity and extensibility are likewise evaluated. It is observed that the elasticity of the dough varies according to the salting agent used. As a matter of fact, the elasticity of E1 is greater than that of T1, which is itself greater than that of T2. Additionally, the moulding extensibility is identical to the extensibility measured during kneading, for breads T1 and T2, whereas, for bread E1, it decreases between kneading and moulding. For breads T1 and E1, the elasticity of the dough did not change between kneading and moulding. However, the elasticity of the dough decreased for bread T2.

When the bread is baked, it is observed that the blade cut is identical between breads E1 and T1 but is less with bread T2. Furthermore, the volume of the bread is slightly greater with bread T1. In addition, it is observed that the taste of bread E1 is in-between bread T1 and bread T2, and that the taste of breads E2 and E3 has a slight metallic after-taste which can be explained by the presence of potassium chloride. Consequently, in one embodiment of the invention, the salting composition does not comprise potassium chloride.

The composition according to the invention can likewise be used in the agro-processing industry as a salting agent for poultry stock, tomato sauce, bechamel sauce, pizza or ham. The impact of the composition according to the invention on an overwhelming salty flavour and on aftertaste appears only at mixture 1 sodium chloride substitution rates of greater than 50%. In addition, colour tests have demonstrated that the use of the composition of the invention made it possible to obtain shinier and/or more intensely coloured products. In particular, the bechamel sauce produced by using a composition according to the invention is yellower and shinier.

1. A composition comprising: (a) at least one of potassium carbonate and bicarbonate, and (b) a potassium organic salt.

2. The composition of claim 1, wherein the weight ratio of potassium organic salt to potassium carbonate or bicarbonate is chosen from among the values ranging from 1 to 10, particularly from 1.5 to 7.5, and in particular from 2 to 4, or even 3.

3. A composition comprising: (a) potassium chloride, (b) a potassium organic salt, and (c) at least one of sodium carbonate and bicarbonate.

4. The composition of claim 3, wherein the weight ratio of potassium organic salt to potassium carbonate or bicarbonate is chosen from among the values ranging from 1 to 10, particularly from 1.5 to 7.5, and in particular from 2 to 4, or even 3.

5. The composition of claim 1, further comprising a sodium chloride content lower than or equal to 2% by weight in relation to the total weight of the composition.

6. The composition of claim 1, wherein the potassium organic salt is chosen from the group comprising citrate, tartrate, adipate, succinate, glutamate and potassium malate, and potassium citrate.

7. The composition of claim 1, further comprising a potassium organic salt content ranging from 50 to 95%, and preferably from 60 to 80% by weight in relation to the total weight of the composition.

8. The composition of claim 1, being devoid of glutamic acid, calcium salt and/or ammonium salt.

9. The composition of claim 1, further comprising silica.

10. A method of preparing a food product comprising at least one step consisting in adding the composition as claimed in claim 1 to a food product.

11. The method of claim 10, wherein the food product is chosen from the group comprising bread, prepared meals, soups, sauces, pizzas, meats, delicatessen foods, and preferably bread.

12. A use of a composition as claimed in claim 1 as a salting agent.

13. A use of a composition as claimed in claim 1 as a sodium chloride substitute.
